(19) United States
(12) Patent Application Publication
(10) Pub. No.: US 2011/0173495 A1
(43) Pub. Date: Jul. 14, 2011

(54) Method and System for Reliable Intersystem Message Notification

(75) Inventors: Zhilong Qian, Hangzhou (CN); Li Cheng, Hangzhou (CN); Lei Li, Hangzhou (CN)

(73) Assignee: Alibaba Group Holding Limited, Grand Cayman (KY)

(21) Appl. No.: 12/294,895

(22) PCT Filed: Mar. 23, 2007
(86) PCT No.: PCT/CN2007/000942

§ 371 Date: Jun. 1, 2010

(30) Foreign Application Priority Data
Mar. 27, 2006 (CN) 200610067456.5

(51) Int. Cl. G06F 11/14

(52) U.S. Cl. 714/18; 714/E11.113

(57) ABSTRACT

The present disclosure discloses a method and apparatus for reliable intersystem message notification that can ensure reliable delivery of notification messages. The method includes the following steps: storing notification messages persistently; sending a new stored notification message or a retry notification message; and resending the notification message in an event that there is a failure of message notification. The described method and apparatus support multiple transmission protocols between different systems. The receiving party can reliably receive notification messages without implementing complicated interaction protocols. The present disclosure therefore is applicable for widespread use in the Internet. Moreover, the method and apparatus also supports multiple transaction processing, can be used as an universal business transaction application platform, and at the same time allows flexible expansion of multiple transactions and multiple protocols.

### CROSS REFERENCE TO RELATED PATENT APPLICATIONS

This application is a national stage application of international patent application PCT/CN07/00942 filed Mar. 23, 2007, which claims priority from Chinese Patent Application No. 200610067456.5, filed Mar. 27, 2006, which applications are hereby incorporated in their entirety by reference.

### TECHNICAL FIELD

The present disclosure relates to the field of data transmission and, more particularly, to a method and apparatus for reliable intersystem message notification.

### BACKGROUND

With the rapid development of Internet technologies, there are an increasing number of Internet application systems that use message notification as their mode of interaction. One such typical application of current message notification is message notification between online banks and merchants. In one application scenario, a user submits a transaction order from a merchant website to an online bank and makes an actual payment through the online bank. After the payment is complete, the online bank will inform the merchant a result of successful payment in a form of message notification. The merchant then completes the remainder of the transaction, such as delivery of goods to the user. Whether the message notification of the payment result is reliably arrived at and received by the merchant will directly affect the transaction flow of the user. Therefore, the reliability of delivery of message notification is very critical.

However, the Internet is unreliable. Its unreliability is reflected in the unpredictability of network connectivity and time delays. This unreliability is also reflected in the unpredictability of the availability of hardware and software that are connected over the Internet. Therefore, there exists a certain loss rate for Internet-based message notifications. However, information flow in electronic commerce requires high reliability. Loss of critical message notifications not only hinder the smooth process of business activities but also cause financial losses to the parties involved in the business activities. In reality, there is still no reliable delivery of intersystem message notification between the banks and the merchants. For instance, according to statistics of iResearch in 2005, message loss rate is quite high for most of the third-party payment platforms in China. Specifically, many results of successful user payment made through online banks have not been successfully delivered to third-party payment platforms, among which the highest order loss rate of online payment platforms is 20%.

WS-Reliable Messaging (Web Service Reliable Messaging Protocol) and WS-Reliability (Web Service Reliability) are two reliable messaging protocols for web service. WS-Reliable Messaging is a protocol proposed by companies such as IBM, BEA, Microsoft and TIBCO to perform reliable message transmission in a distributed system. WS-Reliability, on the other hand, is proposed by Web-Service Reliable Messaging (WSRM) Technical Committee of OASIS. WS-Reliability is a SOAP-based protocol to ensure delivery of SOAP (Simple Object Access Protocol) messages without duplicates. Essentially, these two protocols are both based on arranging the order of messages and employ sliding window protocol to validate the messages to achieve reliable message transmission.

The HTTPLR protocol is proposed by Propylon Ltd. of Ireland in 2005 and is an application layer protocol based on the HTTP protocol for providing a message transmission service with guaranteed and single delivery. HTTPLR provides a reliable message transmission mechanism for upstream messaging (from client to server) and downstream messaging (from server to client). However, this protocol is not concerned with the availability of the message sending end and the message receiving end, the robustness of the components, the persistent storage of the messages, and retry and timeout mechanism for the messages. It is primarily concerned with how both parties of a message exchange achieve a consistent understanding of whether the message is successfully delivered.

In reality, none of the WS-Reliable Messaging, WS-Reliability, or HTTPLR protocols has received wide acceptance in the Internet environment. The main reasons are as follows. First, these protocols are still evolving, and some are even in draft stage. Second, even though mechanisms of reliable message transmission are theoretically described, these protocols do not describe the detailed implementation mechanisms. Third, these protocols have limited application environments. For example, HTTPLR is based on the HTTP protocol, while the WS-Reliable Messaging and WS-Reliability protocols are used for web services. Fourth, these protocols have relatively complicated implementation requirements for clients and servers. For instance, systems on both communication ends need to support the same reliable message transmission mechanism. In the current Internet environment, it is often very difficult to require both parties in a message exchange to implement the same complicated protocol.

### SUMMARY

The present disclosure provides a method and apparatus of reliable intersystem message notification applicable between any collaboration systems. The method and apparatus are particularly useful in solving the problem of irreparable loss of transmitted messages due to instability of the network, servers and software systems when either end of a communication does not support various protocols for reliable message delivery.

The present disclosure provides a method of reliable intersystem message notification. The method includes the following steps:
storing a notification message;
sending the stored notification message; and
resending the notification message in an event that there is a failure of message notification.

Preferably, the notification message is a message required by business application to notify an opposite end system. The failure of message notification includes a failure of receiving message returned from the opposite end system or a failure of receiving a successful transaction complete message returned from the opposite end system.

Preferably, prior to sending the stored notification message, the method further includes: determining whether a business transaction associated with the notification message is completed; and triggering sending the notification message if affirmative, or waiting until the business transaction is completed to trigger sending the notification message.

Preferably, the business transaction is a payment made by a user through an online bank. The notification message is a payment result of the user. The successful transaction complete message at the opposite end system includes a message relating to shipping information of a merchant.

Preferably, sending the stored notification message includes: determining an address and a transmission protocol of the opposite end system according to a transaction type of the notification message; and sending the notification message to the address using the transmission protocol.

Preferably, prior to resending the notification message, the method also includes: determining a time interval for resending the notification message; and computing a retry time according to the time interval.

The resending of the notification message is performed when the retry time is reached.

Preferably, resending notification message further includes: identifying, at a preset period, the notification message that is due for retry; and resending the identified notification message.

Preferably, the time interval for retry increases as a number of retries increases.

Preferably, the method also includes: deleting the stored notification message if the corresponding message notification is successful.

The present disclosure also provides an apparatus of intersystem message notification. The system includes:
a database configured to store a notification message;
a notification client configured to save the notification message into the database and to trigger sending the notification message; and
a notification server configured to send the notification message, and to resend the notification message in an event that there is a failure of message notification.

Preferably, the notification message is a message required by business application to notify an opposite end system and is sent from the business application to the notification client. The failure of message notification includes a failure of receiving message returned from the opposite end system or a failure of receiving a successful transaction complete message returned from the opposite end system.

Preferably, the apparatus further includes a transaction synchronizer installed at the notification client. The transaction synchronizer is configured to trigger sending the notification message after the business transaction associated with the notification message is completed.

Preferably, the notification server includes: a notification execution unit configured to send the notification message and to set up a retry time for the notification message in the database in an event that there is a failure of message notification; and a notification recovery unit configured to identify whether there is any notification message having a due retry time and to trigger the notification execution unit to resend the identified notification message in an event that there exists such notification message.

Preferably, the notification recovery unit runs at set times.

Preferably, the apparatus also includes a message queue. Through the message queue, the notification client triggers the notification execution unit to instantly resend the notification message.

Preferably, the apparatus also includes at least one business transaction plug-in corresponding to each transaction type. The business transaction plug-in is configured to provide an address and a protocol of the opposite end system of the corresponding transaction type to the notification execution unit, and to determine whether the business transaction is successful based on a message received from the opposite end system.

Preferably, the notification server also includes at least one protocol adaptor corresponding to each transmission protocol. The protocol adaptor is configured to transmit the notification message from the notification server using the corresponding transmission protocol.

Preferably, the retry time interval between the retries increases as a number of retries increases.

The present disclosure is applicable between any collaboration systems. By storing the notification message and resending the notification message to the opposite end system if the notification fails, the present disclosure releases the opposite end system from depending on a particular reliable messaging transmission protocol. Instead, in order to reliably receive a notification message, the opposite end system only needs to return a processing result of the message according to a business transaction requirement. Since the notification message is persistently stored until the message is successfully sent, the present disclosure can prevent the loss of the notification message caused by failures of network and hardware or software of the opposite end system, thus ensuring reliable delivery of the notification message.

Furthermore, the present disclosure triggers the process of sending the notification message after completion of the business transaction and determines whether resending the notification message based on whether the result of the business transaction of the opposite end system is successful. This not only provides reliable message notification when failures occur in a transmission layer or layers below, but also provides reliable message notification when an error occurs in the business transaction processing at an application layer. As such, consistency between business transaction processing and message notification is achieved.

Moreover, the method and apparatus of the present disclosure provide a practical and efficient way of handling timeout and message resending to target the pattern of short term and mid-long term communication failures over the Internet. As the number of retries increases, the interval between retry times also increases. The change in the retry time interval gives a balanced consideration of timeliness and efficiency of notification recovery. For short term communication failures, the disclosure can timely send a message notification to the opposite end system after the failure is fixed. For mid-long term failures the cost of making too many unnecessary retries can be avoided.

Moreover, by extending the protocol adaptor, the present disclosure is applicable to different messaging transmission protocols to satisfy broad needs of the Internet.

Moreover, the method and apparatus of the present disclosure can further be used as a universal platform which supports operations of different business applications through expanding business transaction plug-ins to allow flexible development of new business.

### DESCRIPTION OF DRAWINGS

The present disclosure will be described in further details with reference to the following figures and exemplary embodiments.

FIG. 1 shows a schematic diagram of an apparatus and a system for reliable intersystem message notification in accordance with the present disclosure.

FIG. 2 shows a flow chart of a method for reliable intersystem message notification in accordance with the present disclosure.

FIG. 3 shows a flow chart of a registration process of the message notification in the disclosed message notification method.

FIG. 4 shows a flow chart of sending the notification message in accordance with the disclosed message notification method.

FIG. 5 shows a flow chart of recovering a message notification in accordance with the disclosed message notification method.

FIG. 6 shows a conceptual diagram of a method for determining retry intervals for sending a notification message in accordance with the present disclosure.

### DETAILED DESCRIPTION

As Internet-based electronic commerce occupies an increasingly important position in today's society, an increasing number of business entities organize flow of information flow, flow of funds, and flow of logistics over the Internet. A number of Internet application systems using message notifications as the interaction mode is on the rise. One example is banking After a user completes a payment with a bank, the bank needs to inform a merchant system about the status of the user payment via a notification message. Another example is a third-party secured transaction platform. After a user has advanced a business transaction on the transaction platform, the transaction platform needs to inform a related external merchant system regarding the current status of the business transaction. These are some of the typical examples of Internet-based message notifications. The present disclosure is suitable for use between any systems in collaboration and particularly suitable for the Internet.

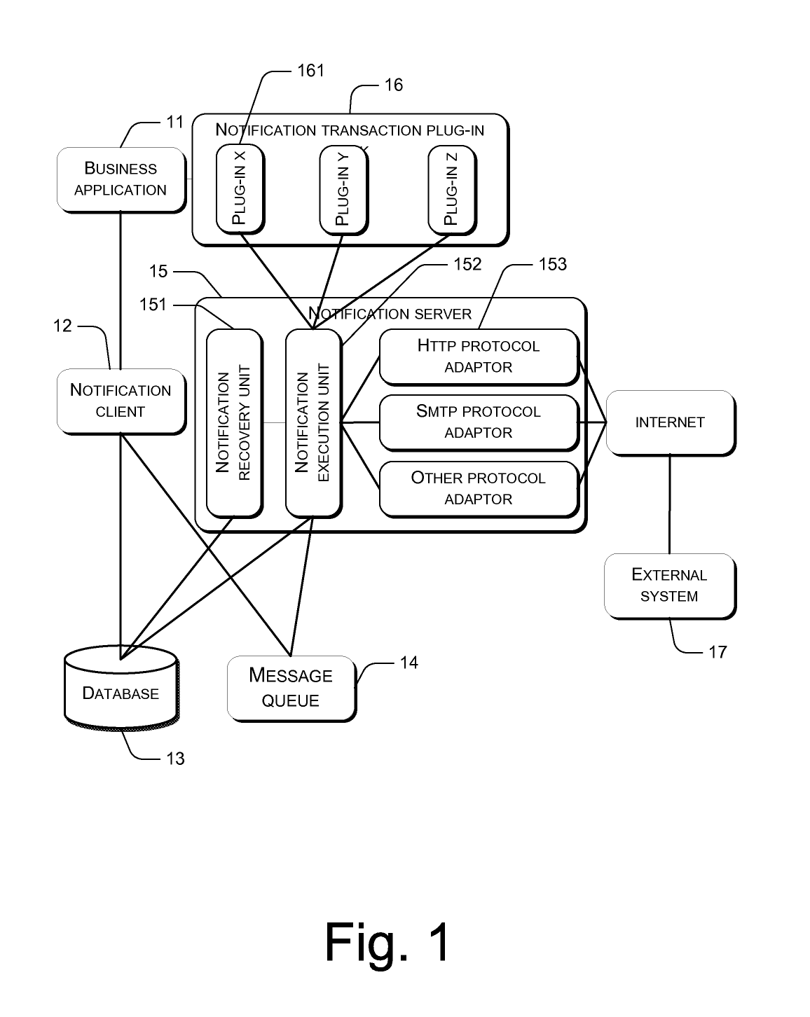

FIG. 1 shows a schematic diagram of an apparatus and a system for reliable intersystem message notification in accordance with the present disclosure. A business application 11 can be any merchant application and initiates the process of message notification. An external system 17 can be any merchant system and is a receiver of the notification message. The notification apparatus in the present disclosure is configured to send the notification message received from the business application 11 and to ensure reliable delivery of the notification message to the external system 17 through the Internet. The notification apparatus may include: a database 13, a notification client 12, a notification execution unit 152, and a notification recovery unit 151.

The database 13 stores the notification message to be sent. The notification message to be sent includes a new notification message that has not been sent and a notification messages that is waiting to be resent.

The notification client 12 saves the notification message into the database 13 and triggers, through a message queue 14, an immediate delivery of the notification message.

The notification execution unit 152 sends the new notification messages or the notification messages that need to be resent. If a delivery of the notification message is successful, the notification execution unit 152 will delete this notification message from the database 13. Otherwise, the notification execution unit 152 will set up a retry time for the notification message and update a corresponding parameter of the notification message in the database 13, i.e., the retry time of the notification message in the database 13.

The notification recovery unit 151 checks whether or not the retry time of any notification message waiting to be resent is due. If the retry time of any notification message is due, the notification recovery unit 151 notifies the notification execution unit 152.

As shown in FIG. 1, the database 13 can be any commonly used relational database and is configured to store new notification messages that are waiting for delivery as well as notification messages that failed previous delivery and are now waiting to be resent. The notification client 12 can be a client module used by the business application 11 and may be embedded in the business application system. The business application 11 can use the notification client 12 to register the notification message. Once the registration of the notification message is successful, the notification apparatus can ensure to deliver the notification message to the receiving party of the message even if the message receiving party is offline or the network is temporarily disconnected. The registration process of notification message is described in the following paragraph.

The notification client 12 stores a notification message, received from the business application 11, in the database 13 and triggers an immediate delivery of the notification message through the message queue 14. The business application system refers to a system that processes relevant transactions in connection with the business application 11. As an example of a message notification between an online bank and a merchant, the business transaction associated with the notification message refers that the user makes an actual payment with the online bank. If the payment is complete, the business transaction is submitted. Otherwise, the business transaction is still in progress. The notification message refers to a result of the user payment, i.e., whether the payment is complete or not. The transaction is a technical term and represents a group of operations having Atomicity, Consistency, Isolation and Durability (ACID) characteristics. The ACID characteristics of the transaction are essential to realization of 100% consistency between message notification and transaction operation. When a transaction is created, it is desirable to ensure that the transaction has some self-managing characteristics such as the ACID characteristics. The ACID characteristics of a transaction are critical elements for achieving a 100% consistency between message notification and business operation.

Embedding notification client 12 into the business application system allows the completion of business transaction processing and registration of notification message in the same database transaction, and completely avoids the inconsistency between business transaction processing and message notification. Here, consistency means that the notification message can be successfully registered and instantly sent only after the corresponding business transaction is completed and submitted. The database used in the database transaction can be the system's database that stores the notification message. Generally, this database is the same database in the business application system for storing the business transaction data. In an event that the two databases are the same, it allows the implementation of registration of notification message and processing of business transaction data in the same database transaction without using a complicated, distributed transaction mechanism with low efficiency. However, the consistency between registration of notification message and processing of business transaction data can be maintained through a distributed transaction mechanism using different databases.

The message queue 14 may be a standard middleware for asynchronous information communication between systems. Using message queue 14, the processes of sending and receiving messages are asynchronous, while the sending party and the receiving party of a message do not make direct communication but communicate indirectly through the message queue 14. To a great extent, this reduces the mutual dependence between the sending party and the receiving party of the message and therefore allows both parties to perform their respective tasks relatively independently. Existing message queues are generally capable to instantly send the message to the receiving party upon receiving the message from the sending party, as long as the receiving party of the message is in normal operation. In this exemplary embodiment, the message queue 14 is configured to trigger an immediate delivery of the notification message.

A notification server 15 can be one server or a group of independent servers that are responsible for sending and resending notification messages. The notification server 15 may include the notification recovery unit 151, the notification execution unit 152 and various protocol adaptors 153. The notification recovery unit 151 is a module responsible for scheduling to resend at set times the notification messages that have not been successfully delivered. The notification execution unit 152 is a module responsible for executing an actual delivery of the notification message. Each of the various protocol adaptors 153 supports a respective transmission protocol and completes an actual data transmission with the external system 17 through the Internet. A business transaction plug-in library 16 includes various business transaction plug-ins 161. The business transaction plug-ins 161 correspond to different transaction types and are responsible for pre-processing before sending the notification messages and processing returned result messages. The pre-processing and the return processing are closely related to the business applications. Different business applications will generally have different handling processes.

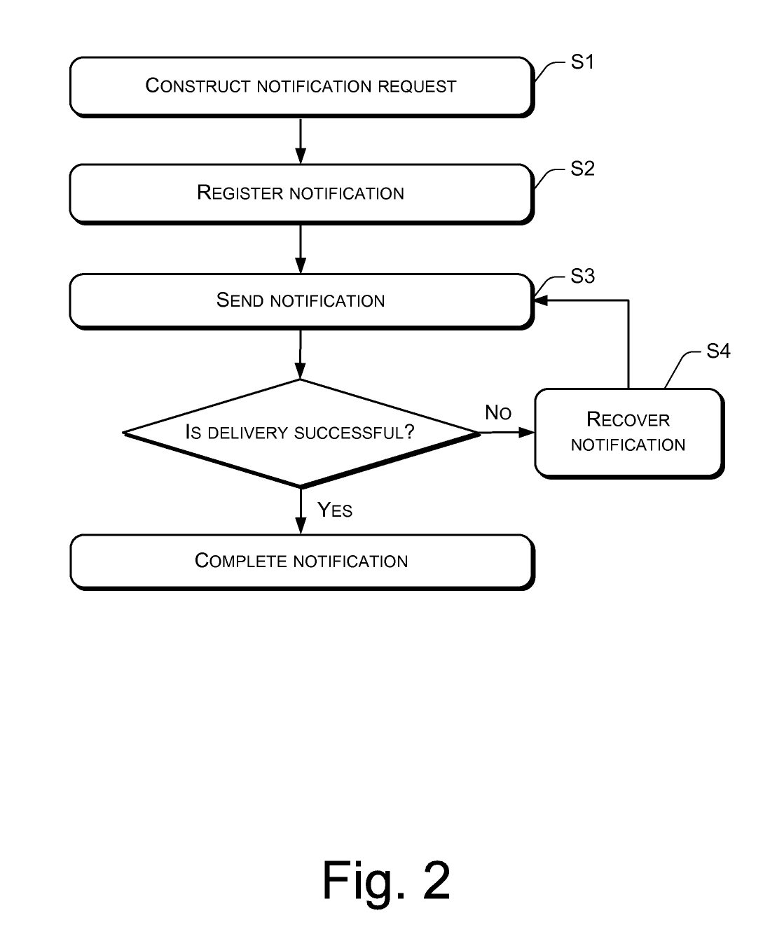

FIG. 2 shows a flow chart of a method for reliable intersystem message notification in accordance with the present disclosure. When the business application needs to send a notification message to an external system, reliable delivery of the notification message can be achieved by performing the steps described below.

At S1, the business application packages its notification needs into a message notification request and sends this request to the notification client of the notification apparatus.

At S2, the notification client registers the notification message. Once registration of the notification message is successful, the business application can continue to perform other transactions, and the notification apparatus ensures the delivery of the notification message to the receiving party, even if the receiving party of the message is offline or temporarily disconnected at the time.

At S3, after the notification message is successfully registered, the notification apparatus sends the notification message. If the receiving party is successfully notified, the task of message notification is completed. Otherwise, the process will proceed to S4. In the present disclosure, a successful message notification includes a successful delivery of the message to the receiving party and a successful transaction processing result returned from the receiving party.

At S4, a recovery of message delivery is performed and the notification messages that failed previous deliveries are scheduled to be re-sent at a proper time. The process then proceeds to S3.

The process can execute S4 at the same time that the step S1, S2 or S3 is executed. In the following, the steps S2, S3 and S4 are each individually described in further details.

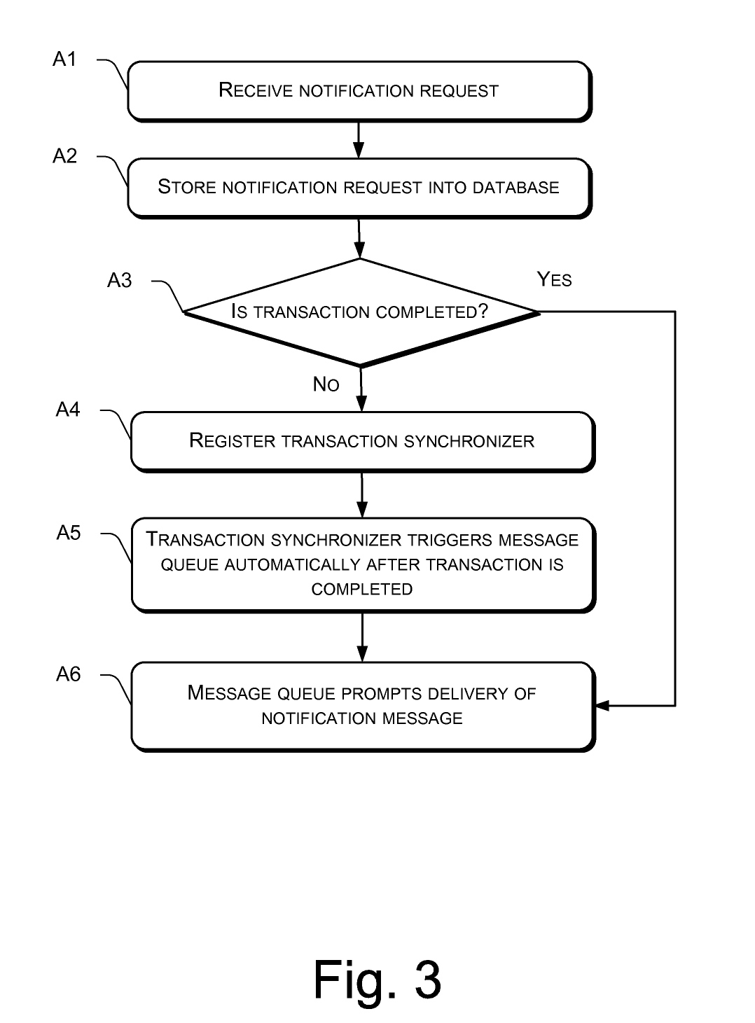

FIG. 3 shows a flow chart of a registering process of the message notification. The registration includes the following steps as described below.

At A1, the notification client receives a message notification request from the business application. The message notification request may include a content of the notification message.

At A2, the notification client stores the message notification request in the database until the corresponding notification message is successfully sent. This can avoid an irreparable loss of the notification message due to instability of the network, the server or the software system during the transmission.

At A3, the notification client determines whether or not the business transaction associated with the notification message has been completed. If the business transaction is still in progress, the process continues to perform steps A4, A5 and A6. If the business transaction is completed, the notification client will automatically trigger the message queue and the process will directly proceed to A6. As an example of the message notification between the online bank and the merchant, the business transaction associated with the notification message can be that the user makes the payment using the online bank. If the payment is completed, the transaction is submitted. Otherwise, the transaction is still in progress. The notification message can be a result of the user payment indicating whether or not the payment has been completed. In the current exemplary embodiment, since the notification client is embedded in the business application system, it can complete registration of the message notification request in the database within the business transaction. This can achieve consistency between the business transaction processing and the registration of notification request without using complicated mechanisms.

At A4, the notification client registers a transaction synchronizer with a transaction management unit. The transaction management unit refers to a software that manages transactions and includes the transaction synchronizers. The transaction synchronizer is set up at the notification client and is configured to send a request for immediate delivery of the notification message to the notification server through the message queue after the associated transaction is submitted. This can ensure timeliness of the notification.

At A5, after the transaction is completed, the transaction synchronizer triggers the message queue automatically.

At A6, the message queue sends to the notification execution unit a request for immediate delivery of the notification message, prompts the notification server to perform delivery, and thus ensures the instantaneity of the notification.

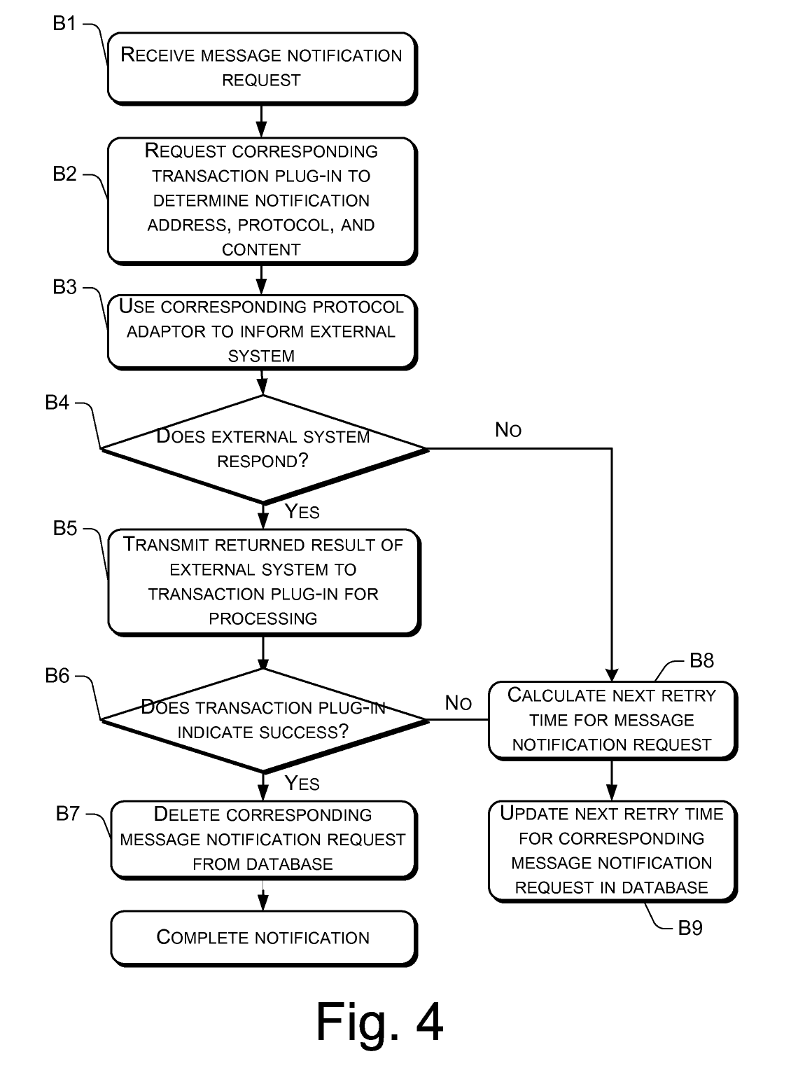

FIG. 4 shows a flow chart of a notification message delivery process. The delivery process is described below.

At B1, the notification execution unit receives a new message notification request from the notification client sent through the message queue, or a message notification retry request sent from the notification recovery unit. If the new message notification request from the message queue and the message notification retry request from the notification recovery unit are received at the same time, the notification execution unit preferably performs a multithread processing and sends both the new notification message and the retry notification message at the same time. Alternatively, the notification execution unit can send them based on determined priorities.

At B2, the notification execution unit selects a business transaction plug-in from a business transaction plug-in library according to the type of the message notification request, and sends the message notification request to the business transaction plug-in for pre-processing to obtain actual notification address, notification protocol and notification parameters of the external system.

At B3, the notification execution unit selects a suitable protocol adaptor based on the notification protocol and provides the content of notification message, the notification address and the notification parameters to the protocol adaptor for actual message delivery.

At B4, if the network, server and systems of both parties are in normal operation, the message is delivered to the external system through the Internet. After receiving and processing the message, the external system returns a processing result. Otherwise, the notification execution unit can automatically detect that the notification message did not reach the external system, and the process will continue to perform steps B8 and B9.

At B5, the notification execution unit sends the returned result to the business transaction plug-in and let the business transaction plug-in complete the corresponding business transaction processing. In the above example, upon receiving the returned result of an external merchant, the business transaction plug-in may need to update the status of the trade to “item shipped”, record the details of the shipping slip, and notify the user about the shipping status. Since the notification server is used for general purpose and not related to any particular type of business transactions, the above processing is carried out by the business transaction plug-in.

At B6, the business transaction plug-in determines whether a retry for message delivery is needed. The business transaction plug-in makes the decision based on whether or not there is a returned result and whether or not the format and content of the returned result are valid. Still using the above example for illustration, if the returned result includes valid shipping information of the merchant, the business transaction plug-in will determine the message notification to be successful. If no returned result is received, the returned result has invalid format, or the merchant indicates explicitly in the returned result that it is temporarily unable to process and needs a certain period of time for retry, the business transaction plug-in will then determine this message notification to be unsuccessful and that there is a need for retry.

Possible reasons of a failure of message notification include not only failures of the network or system but also whether the business transaction is successfully processed or not. The general-purpose notification server can only determine whether there are failures in the network and systems, but cannot decide whether the business transaction itself is successful. Thus the determination responsibility is taken by the business transaction plug-in. Nevertheless, since obvious failures of the network and systems can be determined by the notification server, under such circumstances the notification server directly decides whether a retry is needed.

At B7, if the business transaction plug-in determines that no retry is needed, the notification server will delete the corresponding message notification request from the database and successfully complete the delivery of the notification message.

At B8, if the notification message cannot reach the external system due to various reasons such as network problems, or if the business transaction plug-in indicates that a retry for the message is needed, the notification server will calculate the time interval for the next retry according to a retry strategy and set a next retry time for a next delivery that is equal to a current time plus the calculated time interval.

At B9, with respect to the notification messages waiting to be resent, the notification server updates sending times of corresponding message notification requests in the database according to the calculated retry times, and waits for the re-scheduling by the notification recovery unit.

By expanding business transaction plug-ins, the above process of sending notification messages can provide support to various types of transaction notifications using the same message notification apparatus. By extending protocol adaptors, this process can implement notifications supporting different protocols in the same message notification apparatus. Moreover, the receiving party of the notification message has no need to implement any special secure messaging transmission protocol, and only needs to return the message processing result according to the business transaction requirement in order to reliably receive messages from the sender of message notification.

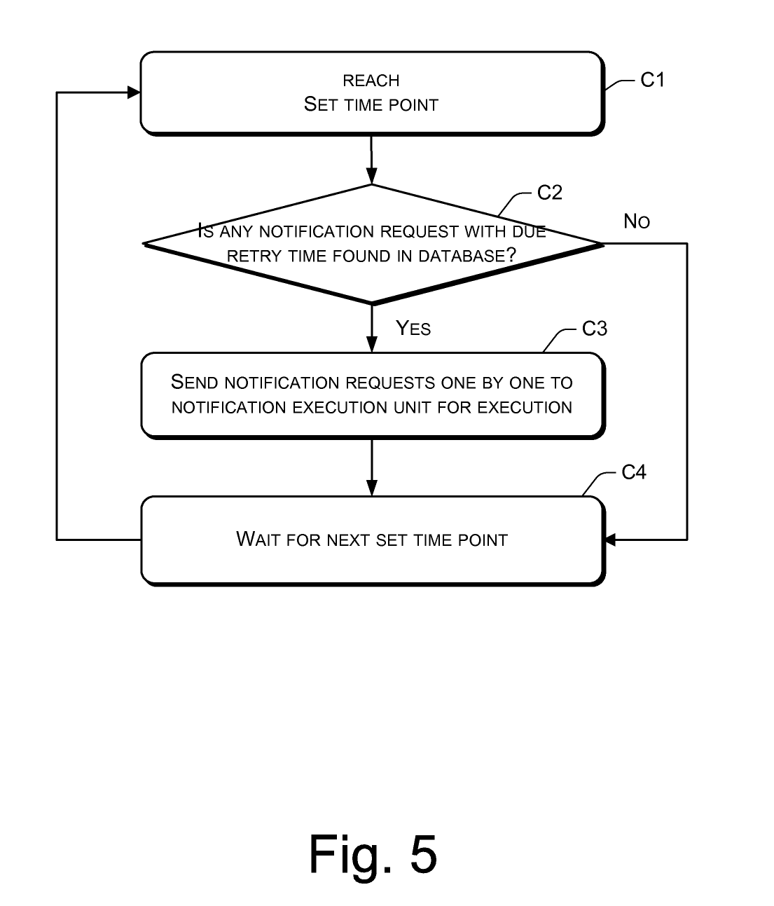

FIG. 5 shows a flow chart of recovering the message notification. The notification process enters into a notification recovery mode when the notification message needs to be resent. Preferably, the notification recovery unit runs at set times. During each run, a number steps are executed as will be described below.

At C1, the notification recovery unit waits for a set time and starts to operate when the time is reached.

At C2, the notification recovery unit searches the database to find those message notification requests that have due retry times. The notification recovery unit checks the message notification requests that need retries, and compares the retry times calculated at B8 of FIG. 4 with the set time of the current run. If any retry time is smaller than or equal to the set time, there exists a message notification request with a due retry time, and the notification process continues to C3. Otherwise, the current run of retry is abandoned, and the process continues to C4.

At C3, with respect to the notification messages whose retry times are due, the notification recovery unit sends a retry request to the notification execution unit and provides the notification messages one by one to the notification execution unit for delivery.

At C4, the notification recovery unit waits for a next set time for the next run.

Normally the set time interval for running the notification recovering process is fixed, such as once a minute for example. The length of the interval between set times has an impact on the timeliness of notification recovery. Therefore it is desirable to set the time interval as small as possible, but this must be within the capacity tolerance of the notification server. It is noted that the set time interval is not the same as the retry time interval for message notification. The retry time interval for message notification is individually calculated and set for each notification message through a retry interval determination method.

At B8 of the process of sending notification messages, the retry strategy can adopt a commonly used fixed retry time interval. Preferably, the present disclosure adopts a following retry interval determination method for determining retry time interval. The retry interval determination method is designed to use a minimum number of retries to maximize the timely delivery of notification messages to the message receiving party, by tailoring to the typical causes of message notification failure over the Internet.

The possible causes of the failure in intersystem message notification over the Internet include: the network is temporarily busy and causes an overtime of transmission protocol; the network temporarily disconnects; the opposite server is temporarily busy and cannot respond to the request; the opposite end has a bug and hence cannot respond to the request or incorrectly processes the request; the opposite server is down and therefore cannot respond to the request; a long-term failure of the network causes hours or even days interruption; a long-term failure of the opposite end system causes hours or even days unavailability; and the opposite end does not exist or has been permanently shut down.

From the above reasons, the causes for a failure of message notification can disappear or be alleviated in a few minutes, but can also last for hours and even days. Accordingly, a preferred retry strategy for message notification should be as follows. When the cause disappears or is alleviated in a few minutes, message notification can be timely sent to the receiving party. When the cause needs several hours or even several days to disappear, the system can still send the message notification to the receiving party without making too many unnecessary retries. Therefore, the present disclosure preferably adopts a following retry interval determination method to determine the retry time interval.

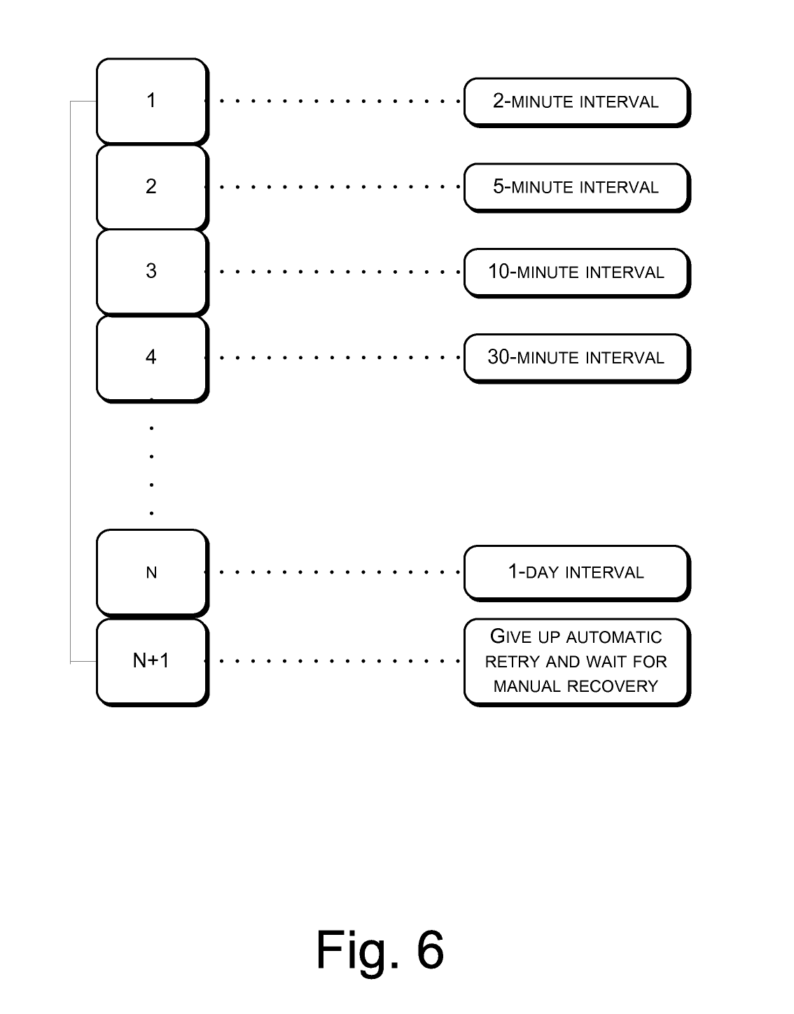

FIG. 6 shows a conceptual diagram of a method for determining retry intervals for sending the notification message. The retry interval determination method is described below.

Assuming there are multiple boxes numbered from 1 to n+1, each box from number 1 to number n is associated with a timer, a higher number of a box, and a longer set time of a corresponding timer. For example, a set time for box number 1 is two minutes, five minutes for box number 2, ten minutes for box number 3, and so forth. The box numbered n+1 has no timer, which indicates that the message is deemed unable to reach the message receiving party forever, and should give up auto-retry to wait for a manual recovery.

After a message notification has failed for the i^{th} (i=1, . . . n) number of time, it will be placed in a box numbered i.

When the set time is reached, the timer of the box numbered i triggers all message notification tasks in this box for retries.

After a message notification has failed for n+1 times, it will be placed into the box numbered n+1. Since there is no timer for the box numbered n+1, the system will give up automatic retry for this message notification and pass this message notification for manual processing.

In addition, the notification system in the present disclosure can also adjust the timer of each box according to the characteristics of different types of external systems in order to conform to the failure pattern of the corresponding external system.

In the retry interval determination method as shown in FIG. 6, if a number of retries for message notifications is small, it indicates that the cause for the failure in sending notification messages has disappeared in a short time. Since the time interval between each retry is small in this case, this can ensure timely delivery of notification messages when the cause is fixed. However, if the number of retries for message notification is large, it indicates that there has been a long-term communication failure causing unsuccessful delivery of notification messages. As subsequent retry time intervals become progressively longer, this will effectively avoid many unnecessary retries and reduce the occupancy of system resources while still ensuring the delivery of the notification message. Therefore, the described retry interval determination method can both ensure timely recovery of message notification in an event of short-term communication failures and avoid many useless retries of notification in an event of long-term communication failures. As such, the described retry interval determination method considers both timeliness and efficiency of notification recovery.

The method and system for reliable intersystem message notification in the present disclosure are suitable for use between any systems in collaboration. Particularly, when the message notification is performed between systems over the Internet, the present disclosure can solve the problem of irreparable loss of notification messages caused by unreliability of the network and failures in hardware and software, and ensure timely and reliable delivery of the message. The present disclosure supports multi-protocol transmissions between different systems. The receiving party can reliably receive notification messages without implementing complicated interaction protocols. The present disclosure is suitable for widespread use in the Internet. The method and apparatus also support multiple business transaction processing, serve as a universal business transaction application, and flexibly expand to multiple business transactions and protocols.

The method and system for reliable intersystem message notification in the present disclosure are described in details above. Exemplary embodiments are employed for illustrate purpose only in this document. In particular, the method and apparatus of the present disclosure are applicable for use between any collaboration systems without restriction to the use between Internet-based systems. The method and apparatus of the present are only optimized to ensure reliable intersystem message notification over the Internet and are particularly suitable for widespread use in the Internet. This optimization should not be interpreted as a limitation to the claims of the present disclosure. The exemplary embodiments are only used for better understanding of the method and core concepts of the present disclosure. Based on the concepts of the present disclosure, a person of ordinary skill in art may make modifications to the detailed implementation and application scopes. In conclusion, the content of this description should not be interpreted as limitations to the claim coverage of the present disclosure.

1. A method of intersystem message notification, the method comprising:
storing a notification message in a database;
obtaining an address, a transmission protocol, and a parameter from the notification message using a business transaction plug-in that corresponds to a transaction type of the notification message;
providing the address, the parameter, and content of the notification message to a protocol adaptor corresponding to the transmission protocol to send the notification message;
sending the stored notification message;
the business transaction plug-in determining whether or not a result is received in response to the notification message and whether or not the result indicates that the notification message needs to be resent;
setting a resend time and storing the notification message when it is determined that the notification message needs to be resent; and
resending the notification message when the resend time is up.

2. The method of intersystem message notification as recited in claim 1, wherein:
the notification message is a message required by a business application to notify an opposite end system; and
the failure of message notification includes a failure of receiving message returned from the opposite end system or a failure of receiving a successful transaction complete message returned from the opposite end system.

3. The method of intersystem message notification as recited in claim 2, wherein the method, prior to sending the stored notification message, further comprises:
determining whether a business transaction associated with the notification message is completed; and
triggering sending the notification message if affirmative, or waiting until the business transaction is completed to trigger sending the notification message.

4. The method of intersystem message notification as recited in claim 3, wherein:
the business transaction is a payment made by a user through an online bank;
the notification message is a payment result of the user; and
the successful transaction complete message at the opposite end system includes a message relating to shipping information of a merchant.

5. The method of intersystem message notification as recited in claim 2, wherein the sending the stored notification message further comprises:
determining an address and a transmission protocol of the opposite end system according to a transaction type of the notification message; and
sending the notification message to the address using the transmission protocol.

6. The method of intersystem message notification as recited in claim 1, wherein the method, prior to resending the notification message, further comprises:
determining a time interval for resending the notification message; and
computing a retry time according to the time interval,
wherein the resending of the notification message is performed when the retry time is reached.

7. The method of intersystem message notification as recited in claim 6, wherein the resending notification message further comprises:
identifying, at a preset period, the notification message that is due for retry; and resending the identified notification message.

8. The method of intersystem message notification as recited in claim 6, wherein the time interval for retry increases as a number of retries increases.

9. The method of intersystem message notification as recited in claim 1, wherein the method further comprises:
deleting the stored notification message in an event that the corresponding message notification is successful.

10. An apparatus of intersystem message notification comprising:
a database that stores a notification message; and
a notification server that sends the notification message and further resends the notification message in an event that there is a failure of message notification.

11. The apparatus of intersystem message notification as recited in claim 10, wherein:
the notification message is a message required by a business application to notify an opposite end system and is sent from the business application to the notification client; and
the failure of message notification includes a failure of receiving message returned from the opposite end system or a failure of receiving a successful transaction complete message returned from the opposite end system.

12. The apparatus of intersystem message notification as recited in claim 11, wherein the apparatus further comprises a transaction synchronizer installed at a notification client, the transaction synchronizer configured to trigger sending the notification message after the business transaction associated with the notification message is completed.

13. The apparatus of intersystem message notification as recited in claim 10, wherein the notification server further comprises:
a notification execution unit configured to send the notification message and to set up a retry time for the notification message in the database in an event that there is a failure of message notification; and
a notification recovery unit configured to identify whether there is any notification message having a due retry time and to trigger the notification execution unit to resend the identified notification message in an event that there exists such notification message.

14. The apparatus of intersystem message notification as recited in claim 13, wherein the notification recovery unit runs at set times.

15. The apparatus of intersystem message notification as recited in claim 13, wherein the apparatus further comprises a notification client and a message queue,
wherein through the message queue, the notification client triggers the notification execution unit to instantly resend the identified notification message.

16. The apparatus of intersystem message notification as recited in claim 13, wherein the apparatus further comprises at least one business transaction plug-in corresponding to each transaction type, the business transaction plug-in configured to provide an address and a protocol of the opposite end system of the corresponding transaction type to the notification execution unit, and to determine whether the business transaction is successful based on a message received from the opposite end system.

17. The apparatus of intersystem message notification as recited in claim 13, wherein the notification server further comprises:
at least one protocol adaptor corresponding to a transmission protocol, the protocol adapter configured to transmit the notification message from the notification server using the corresponding transmission protocol.

18. The apparatus of intersystem message notification as recited in claim 13, wherein the retry time interval between the retries increases as a number of retries increases.
